(19) United States
(12) Patent Application Publication
(10) Pub. No.: US 2015/0259219 A1
(43) Pub. Date: Sep. 17, 2015

(54) Cyclonic/Cross-Flow Hierarchical Filter

(71) Applicant: University of Washington through its Center for Commercialization, Seattle, WA (US)

(72) Inventors: Adam P. Summers, Friday Harbor, WA (US); Erin W. Paig-Tran, Orange, CA (US); Ashley Peterson, Seattle, WA (US)

(21) Appl. No.: 14/645,955

(22) Filed: Mar. 12, 2015

Related U.S. Application Data
(60) Provisional application No. 61/951,936, filed on Mar. 12, 2014.

(51) Int. Cl. C02F 1/00; B33Y 80/00; B01D 29/60; B01D 29/00; B01D 29/52; B01D 29/96

(52) U.S. Cl. CPC C02F 1/008; B01D 29/52; B01D 29/965; B01D 29/60; B01D 29/0093; B33Y 80/00; C02F 2201/002; C02F 2209/105

(57) ABSTRACT

An example filtration device may include a plurality of filter lobes. The filtration device may also include a spine connected to each of the plurality of filter lobes such that each filter lobe is interconnected through the spine. Each of the plurality of filter lobes may be positioned at an angle with respect to a longitudinal axis of the spine such that each of the plurality of filter lobes are parallel to one another. The filtration device may also include a terminal lobe including a surface positioned substantially parallel to the longitudinal axis of the spine. The filtration device may also include a plurality of pores positioned at a distal end of each of the plurality of filter lobes, and a waste channel in fluid communication with each of the plurality of pores.

### CROSS-REFERENCE TO RELATED APPLICATIONS

This application claims the benefit of the filing date of U.S. Provisional Patent Application Ser. No. 61/951,936, filed Mar. 12, 2014, which is hereby incorporated by reference in its entirety.

### GOVERNMENT RIGHTS

This invention was made with government support under grant number IOS-1256602 awarded by the National Science Foundation. The government has certain rights in the invention.

### BACKGROUND

Unless otherwise indicated herein, the materials described in this section are not prior art to the claims in this application and are not admitted to be prior art by inclusion in this section.

A wide range of technologies are currently used to treat, purify and/or filter water. Many such technologies require a relatively large amount of physical space and/or require the use of consumable filters that add to operational costs. Therefore, an improved filtration device and method of use may be desirable.

### SUMMARY

Example devices and methods described herein describe various filtration devices. In one aspect, a filtration device is provided including (a) a plurality of filter lobes, (b) a spine connected to each of the plurality of filter lobes such that each filter lobe is interconnected through the spine, wherein each of the plurality of filter lobes are positioned at an angle with respect to a longitudinal axis of the spine such that each of the plurality of filter lobes are parallel to one another, (c) a terminal lobe including a surface positioned substantially parallel to the longitudinal axis of the spine, (d) a plurality of pores positioned at a distal end of each of the plurality of filter lobes, and (e) a waste channel in fluid communication with each of the plurality of pores.

In a second aspect, a filtration system is provided including a plurality of the filtration devices, wherein each filtration device comprises (i) a plurality of filter lobes, (ii) a spine connected to each of the plurality of filter lobes such that each filter lobe is interconnected through the spine, wherein each of the plurality of filter lobes are positioned at an angle with respect to a longitudinal axis of the spine such that each of the plurality of filter lobes are parallel to one another, (iii) a terminal lobe including a surface positioned substantially parallel to the longitudinal axis of the spine, (iv) a plurality of pores positioned at a distal end of each of the plurality of filter lobes, and (v) a waste channel in fluid communication with each of the plurality of pores, wherein the spine of each of the plurality of filtration devices are disposed on a common surface.

In a third aspect, a method is provided for separating waste particles from a liquid. The method may include (a) receiving a liquid into an inlet of a flow chamber, wherein the flow chamber includes a filtration device, and wherein the filtration device comprises (i) a plurality of filter lobes, (ii) a spine connected to each of the plurality of filter lobes such that each filter lobe is interconnected through the spine, wherein each of the plurality of filter lobes are positioned at an angle with respect to a longitudinal axis of the spine such that each of the plurality of filter lobes are parallel to one another, (iii) a terminal lobe including a surface positioned substantially parallel to the longitudinal axis of the spine, (iv) a plurality of pores positioned at a distal end of each of the plurality of filter lobes, and (v) a waste channel in fluid communication with each of the plurality of pores, (b) capturing a plurality of waste particles from the liquid in the plurality of pores, (c) receiving the plurality of waste particles into the waste channel, and (d) receiving the liquid into an outlet of the flow chamber.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1A is a side cross-sectional view of a filtration device, according to an example embodiment.

FIG. 1B is perspective view of the filtration device of FIG. 1A, according to an example embodiment.

FIG. 1C is a back view of the filtration device of FIG. 1A, according to an example embodiment.

FIG. 2A is a side view of an example filtration device arranged such that the terminal lobe is positioned upstream in relation to the direction of fluid flow, according to an example embodiment.

FIG. 2B is a side view of an example filtration device arranged such that the terminal lobe is positioned downstream in relation to the direction of fluid flow, according to an example embodiment.

FIG. 3 is a side view of an example filtration device positioned at an angle between the longitudinal axis of the spine and the direction of fluid flow, according to an example embodiment.

FIG. 4A is a side view of an example filtration device positioned at an first angle between the longitudinal axis of the spine and the direction of fluid flow, according to an example embodiment.

FIG. 4B is a side view of an example filtration device positioned at an second angle between the longitudinal axis of the spine and the direction of fluid flow, according to an example embodiment.

FIG. 5A is a top view of a filter lobe including a plurality of projections, according to an example embodiment.

FIG. 5B is a top view of a filter lobe including a plurality of protrusions, according to an example embodiment.

FIG. 5C is a top view of a substantially planar filter lobe, according to an example embodiment.

FIG. 6A is a top view of a plurality of filter lobes including a plurality of projections, with fluid flow with the terminal lobe positioned downstream in relation to the direction of fluid flow, according to an example embodiment.

FIG. 6B is a top view of a plurality of filter lobes including a plurality of projections, with fluid flow with the terminal lobe positioned upstream in relation to the direction of fluid flow, according to an example embodiment.

FIG. 6C is a top view of a plurality of filter lobes including a plurality of protrusions, with fluid flow with the terminal lobe positioned downstream in relation to the direction of fluid flow, according to an example embodiment.

FIG. 6D is a top view of a plurality of filter lobes including a plurality of protrusions, with fluid flow with the terminal lobe positioned upstream in relation to the direction of fluid flow, according to an example embodiment.

FIG. 6E is a top view of a plurality of filter lobes having no secondary surface structures, with fluid flow with the terminal lobe positioned downstream in relation to the direction of fluid flow, according to an example embodiment.

FIG. 6F is a top view of a plurality of filter lobes having no secondary surface structures, with fluid flow with the terminal lobe positioned upstream in relation to the direction of fluid flow, according to an example embodiment.

FIG. 7A is top view of an example filtration device, according to an example embodiment.

FIG. 7B is a perspective view of the filtration device of FIG. 7A, according to an example embodiment.

FIG. 7C is a cross-sectional view of the filtration device of FIG. 7A, according to an example embodiment.

FIG. 8 is an example filtration system, according to an example embodiment.

FIG. 9 is a flowchart illustrating an example method according to an example embodiment.

### DETAILED DESCRIPTION

Example methods and systems are described herein. It should be understood that the words “example,” “exemplary,” and “illustrative” are used herein to mean “serving as an example, instance, or illustration.” Any embodiment or feature described herein as being an “example,” being “exemplary,” or being “illustrative” is not necessarily to be construed as preferred or advantageous over other embodiments or features. The example embodiments described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein.

Furthermore, the particular arrangements shown in the Figures should not be viewed as limiting. It should be understood that other embodiments may include more or less of each element shown in a given Figure. Further, some of the illustrated elements may be combined or omitted. Yet further, an example embodiment may include elements that are not illustrated in the Figures.

As used herein, with respect to measurements, “about” means+/−5%.

As used herein, “longitudinal axis” is an axis along the lengthwise direction of a given component, passing through the center of the component.

The present disclosure provides various filtration devices for separating waste particles from a stream of liquid. The filtration devices described herein allow for cross-flow filtration as one mode of filtration, and cyclonic filtration as a further mode of filtration. In particular, an example filtration device may use a combination of cross-flow filtration and cyclonic filtration, and may adjust various parameters of the filtration device to achieve a desired form of filtration. As such, the described devices and methods may be used in a variety of water treatment, fluid filtering and particle separation applications.

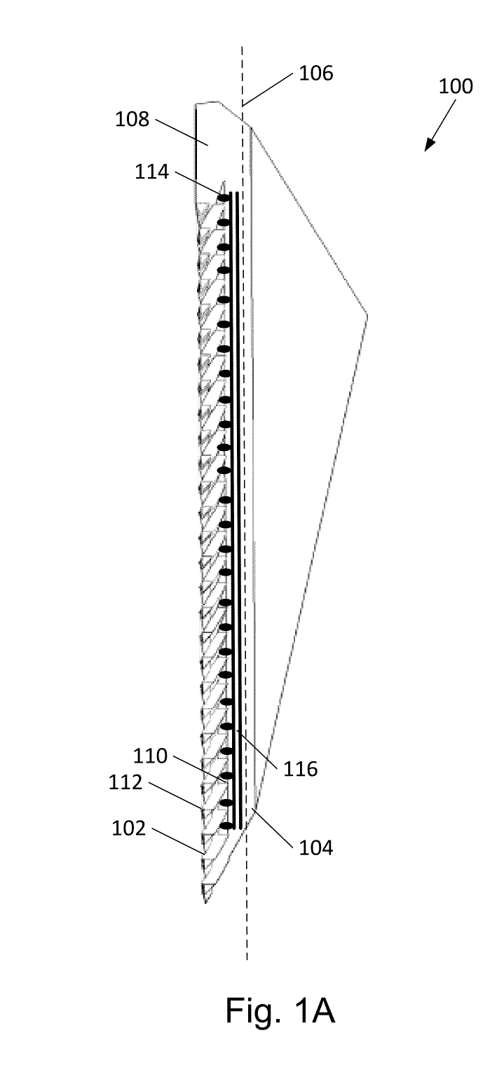

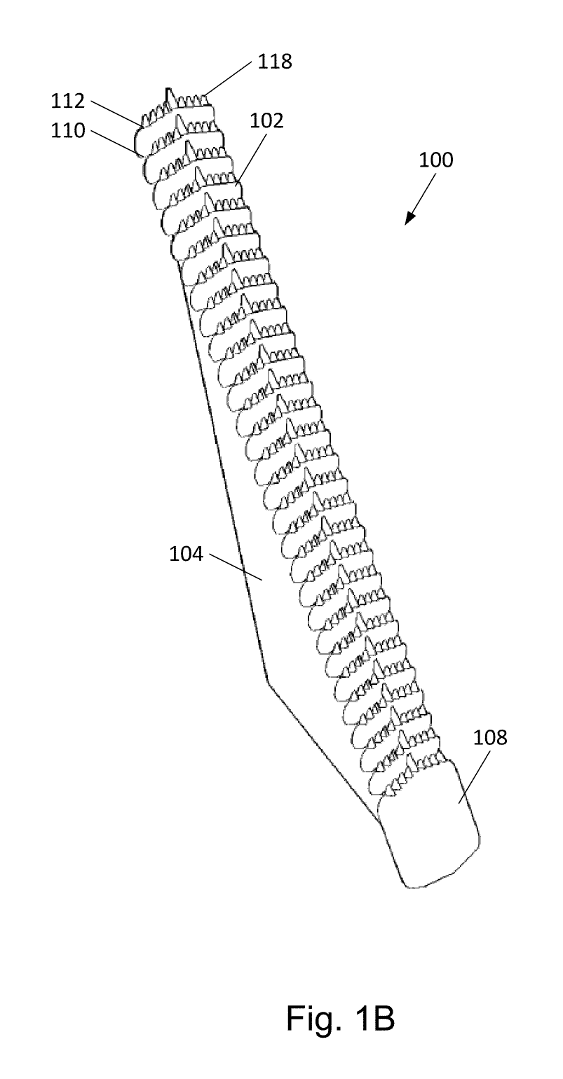

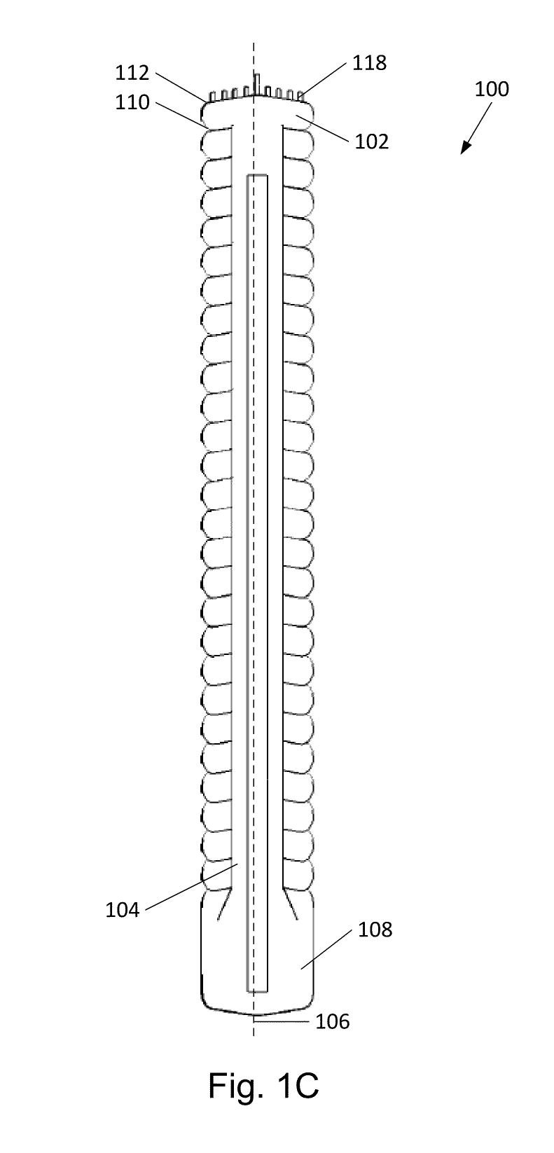

With reference to the Figures, FIGS. 1A-1C illustrate a filtration device 100 according to an example embodiment. In particular, FIG. 1A illustrates a cross-sectional view of an example filtration device 100. As seen in FIG. 1A, the filtration device 100 includes a plurality of filter lobes 102. The filtration device 100 further includes a spine 104 connected to each of the plurality of filter lobes 102. Each of the plurality of filter lobes 102 are positioned at an angle with respect to a longitudinal axis of the spine 106. In one example, the spine 104 is connected to a center of each of the plurality of filter lobes 102. As such, each of the plurality of filter lobes 102 are parallel to one another as positioned on the spine 104. The angle of each of the plurality of filter lobes 102 with respect to the longitudinal axis of the spine 106 is less than about 45 degrees, although other angles are possible as well.

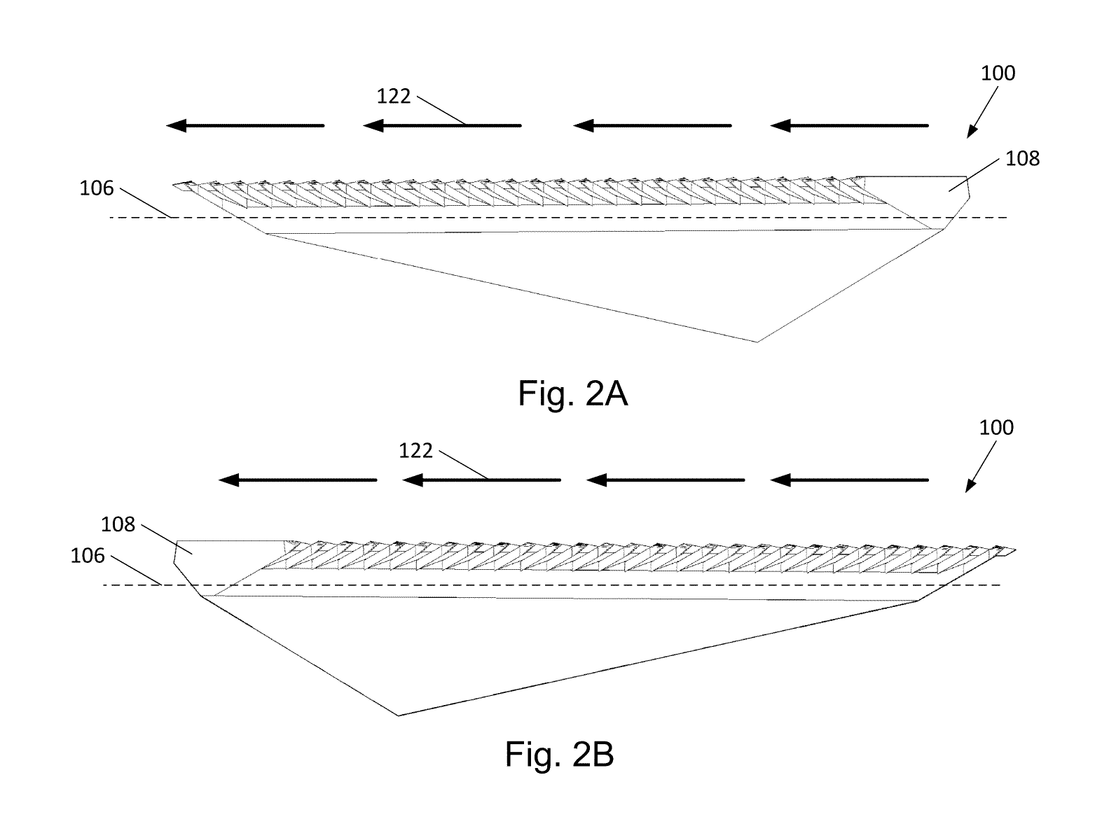

The filtration device 100 further includes a terminal lobe 108 including a surface positioned substantially parallel to the longitudinal axis of the spine 106. As shown in FIG. 2A, each of the plurality of filter lobes 102 are angled towards the terminal lobe 108. In particular, a distal end 110 of each of the plurality of filter lobes 102 is closer to the terminal lobe 108 than a proximal end 112 of each of the plurality of filter lobes 102. The surface of the terminal lobe 108 may be substantially planar and may have a width approximately equivalent to a width of each of the plurality of filter lobes 102. In addition, a plurality of pores 114 may be positioned at the distal end 110 of each of the plurality of filter lobes 102. The plurality of pores 114 may be in fluid communication with a waste channel 116. As shown in FIG. 1A, the waste channel 116 may be disposed within the spine 104 of the filtration device 100.

FIG. 1B illustrates a perspective view of the filtration device 100 of FIG. 1A. As shown in FIG. 1B, the filtration device 100 may further include a plurality of projections 118 extending from the proximal end 112 of the plurality of filter lobes 102. The plurality of projections 118 may be evenly spaced along the proximal end 112 of the plurality of filter lobes 102. FIG. 1C illustrates a back view of the filtration device 100 of FIGS. 1A-1B, further illustrating the plurality of projections 118 extending from the proximal end of one of the plurality of filter lobes 102.

In operation, the filtration device 100 may be positioned within a flow chamber, such as a pipe or other such configuration. In one example, as shown in FIGS. 2A-2B, the filtration device 100 may be positioned such that the longitudinal axis of the spine 106 is positioned substantially parallel to a direction of fluid flow 122 through the filtration device 100. Further, the filtration device 100 may be positioned in two ways with respect to the direction of fluid flow 122.

In a first embodiment, shown in FIG. 2A, the filtration device 100 is positioned such that the terminal lobe 108 is positioned upstream in relation to the direction of fluid flow 122. In such an embodiment, flow across the filtration device 100 is turbulent, which is more conducive to cyclonic filtration. In cyclonic filtration, a vortex is created within the pore 114 of the filter lobe 102. The vortex within the pore 114 entrains particles smaller than the pore size. Such a configuration may be advantageous when the liquid being filtered includes small waste particles that should be filtered out of the liquid. The addition of cyclonic filtration may help capture such small particles more effectively than cross-flow filtration alone. As such particles are captured in the pores 114 of the filter lobes 102, the particles are transported out of the fluid flow 122 through the waste channel 116.

In a second embodiment, shown in FIG. 2B, the filtration device 100 is positioned such that the terminal lobe 108 is positioned downstream in relation to the direction of fluid flow 122. In such an embodiment, flow across the filtration device 100 is laminar, which is more conducive to cross-flow filtration. Laminar flow and cross-flow filtration may be advantageous when the liquid being filtered includes larger waste particles that should be filtered out of the liquid. In general, laminar flow means than the flow rate of the liquid is less than in turbulent flow. The lower flow rate may be advantageous in filtering larger particles to prevent or minimize damage to the filter lobes 102 and other components of the filtration device 100.

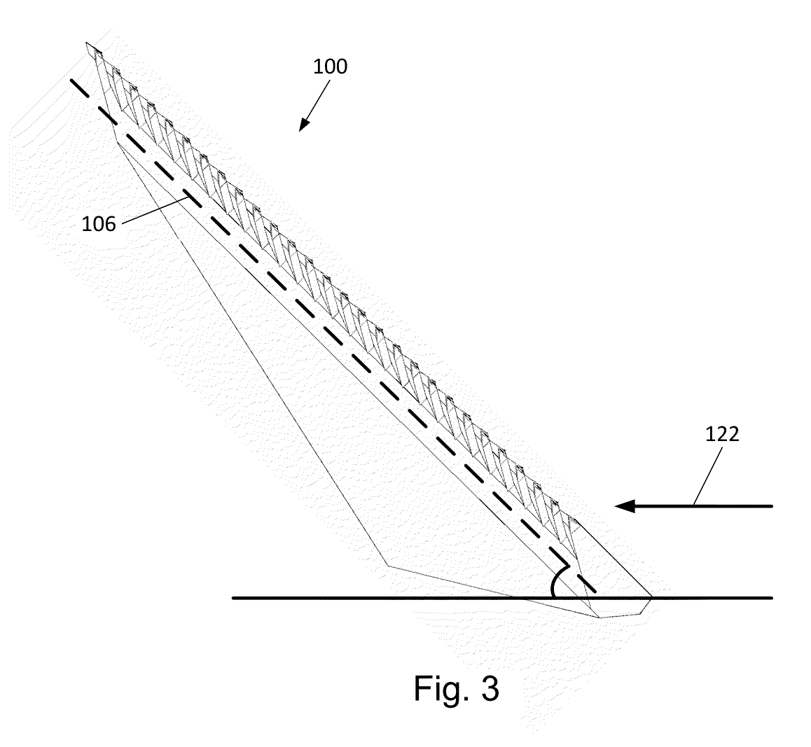

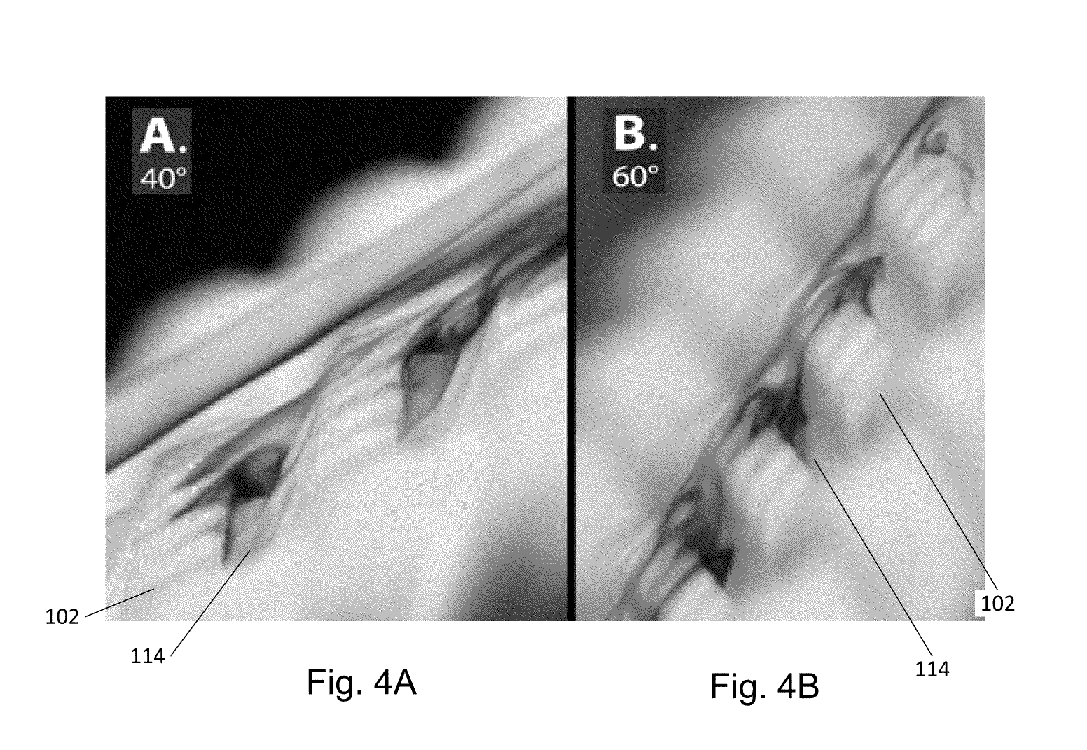

FIG. 3 illustrates the filtration device 100 positioned with an angle between the longitudinal axis of the spine 106 and the direction of fluid flow 122. In one example, the angle may be between 0 degrees (parallel to the direction of fluid flow 122) and 60 degrees. Cyclonic flow may be induced at approximately 40 degrees, although a greater angle may provide more defined cyclonic flow. FIG. 4A illustrates an example embodiment in which the angle between the longitudinal axis of the spine 106 and the direction of fluid flow 122 is about 40 degrees. In contrast, FIG. 4B illustrates an example embodiment in which the angle between the longitudinal axis of the spine 106 and the direction of fluid flow 122 is about 60 degrees. In FIGS. 4A-4B, the terminal lobe 108 is positioned upstream with respect to the direction of fluid flow 122. As shown in FIGS. 4A-4B, as the angle between the longitudinal axis of the spine 106 and the direction of fluid flow 122 increases, flow at the pore 114 of the filter lobes 102 is more organized and increasingly cyclonic in nature.

In some examples, the filtration device 100 may be adjustable such that the angle between the longitudinal axis of the spine 106 and the direction of fluid flow 122 can be changed during operation. In one example, the filtration device 100 may include a motor connected to the spine 104, where the motor is configured to adjust the angle between the longitudinal axis of the spine 106 and a direction of fluid flow 122 through the filtration device 100. Such a motor may be an electric motor powered by electrical power, or may be powered by a number of different energy sources, such as a gas-based fuel or solar power. In another example, the filtration device may include an actuator coupled to the spine 104, where the actuator is configured to adjust an angle between the longitudinal axis of the spine 106 and a direction of fluid flow 122 through the filtration device 100. Such an actuator may be an electro-mechanical actuator, including an electric motor configured to convert a rotary motion of the electric motor to a linear displacement. Other potential actuators are possible as well, such as hydraulic actuators, pneumatic actuators, piezoelectric actuators, linear motors, or telescoping linear actuators, as examples.

In addition, the filtration device 100 may include a controller (e.g., a microprocessor, FPGA, microcontroller, or the like) configured to adjust the angle between the longitudinal axis of the spine 106 and the direction of fluid flow 122. In one example, the filtration device 100 may further include a spectrometer configured to measure a size of particles present in the liquid, and transmit the determined particle size to the controller. The controller may then cause the motor and/or actuator to automatically adjust the angle between the longitudinal axis of the spine 106 and the direction of fluid flow 122 based on the determined particle size. In another example, the angle between the longitudinal axis of the spine 106 and the direction of fluid flow 122 may be adjusted manually via human input at a user interface. Other examples are possible as well.

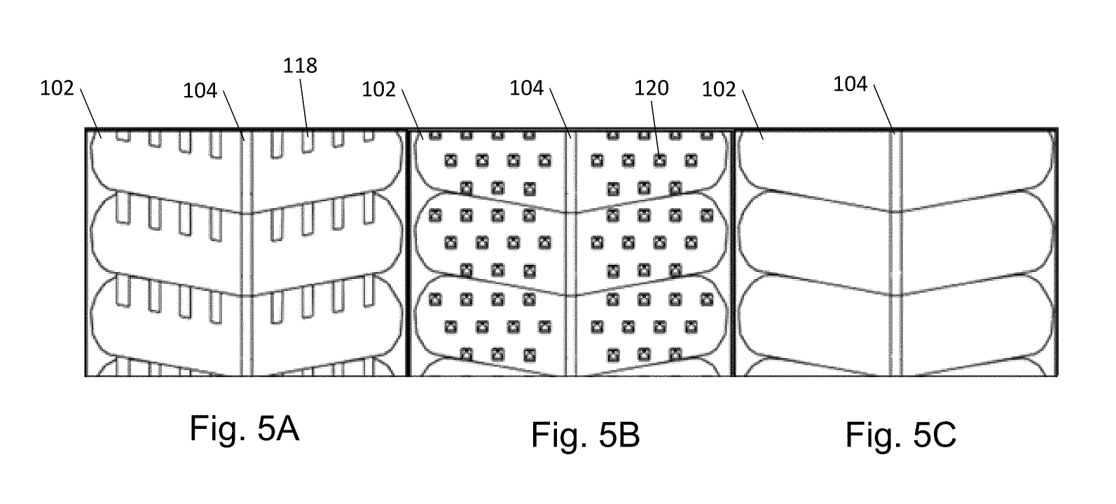

In addition to changing the angle between the longitudinal axis of the spine 106 and the direction of fluid flow 122, the filtration device 100 may include other features that alter the flow of the liquid through the filtration device. As discussed above in relation to FIGS. 1B-1C, the filtration device 100 may include a plurality of projections 118 extending from the proximal end 112 of the plurality of filter lobes 102. In other embodiments, the plurality of filter lobes 102 may include other secondary surface structures instead of or in addition to the plurality of projections 118. In particular, FIGS. 5A-5C illustrate different secondary surface structures that may be present on the plurality of filter lobes 102. FIG. 5A illustrates a top view of a plurality of filter lobes 102 including a plurality of projections 118, such as the projections 118 shown in FIGS. 1B-1C. FIG. 5B illustrates a top view of a plurality of filter lobes 102 including a plurality of protrusions 120 positioned on a surface of each of the plurality of filter lobes 102. As shown in FIG. 5B, the plurality of protrusions 120 may extend from the distal end 110 to the proximal end 112 of each of the plurality of filter lobes 102. The plurality of protrusions 120 may comprise bumps or denticles positioned on the surface of the filter lobes 102. FIG. 5C illustrates a top view of a plurality of filter lobes 102 where each of the filter lobes 102 are substantially planar. As such, the filter lobes 102 shown in FIG. 5C do not include any secondary surface structures. Other example secondary surface structures are possible as well.

In one example, the filtration device 100 may be capable of adjusting the secondary surface structures on the plurality of filter lobes 102. For example, the plurality of projections 118 may be mechanically controlled by the filtration device 100 to move in and out of the plurality of filter lobes 102. As such, the plurality of filter lobes 102 may change from having no secondary surface structures to having a plurality of projections 118. As discussed above, the filtration device 100 may include a controller configured to make such adjustments based on the size of waste particles.

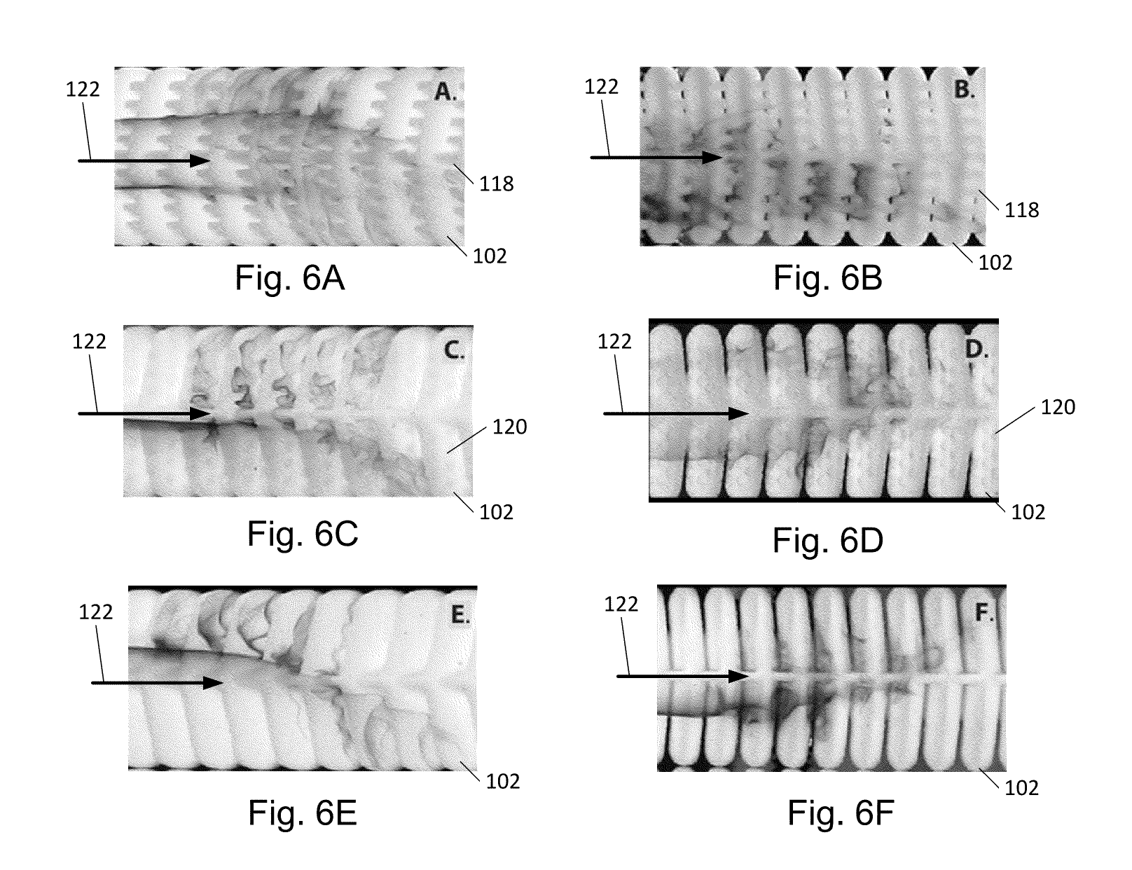

FIGS. 6A-6F illustrate the differences in flow between the different secondary surface structures. In each case, the direction of fluid flow 122 is substantially parallel to the longitudinal axis of the spine 106. In particular, FIG. 6A illustrates a top view of a plurality of filter lobes 102 including a plurality of projections 118, with fluid flow with the terminal lobe 108 positioned downstream in relation to the direction of fluid flow 122. FIG. 6B illustrates a top view of a plurality of filter lobes 102 including a plurality of projections 118, with fluid flow with the terminal lobe 108 positioned upstream in relation to the direction of fluid flow 122. FIG. 6C illustrates a top view of a plurality of filter lobes 102 including a plurality of protrusions 120, with fluid flow with the terminal lobe 108 positioned downstream in relation to the direction of fluid flow 122. FIG. 6D illustrates a top view of a plurality of filter lobes 102 including a plurality of protrusions 120, with fluid flow with the terminal lobe 108 positioned upstream in relation to the direction of fluid flow 122. FIG. 6E illustrates a top view of a plurality of filter lobes 102 having no secondary surface structures, with fluid flow with the terminal lobe 108 positioned downstream in relation to the direction of fluid flow 122. FIG. 6F illustrates a top view of a plurality of filter lobes 102 having no secondary surface structures, with fluid flow with the terminal lobe 108 positioned upstream in relation to the direction of fluid flow 122.

As shown in FIGS. 6A-6F, when the terminal lobe 108 is positioned downstream in relation to the direction of fluid flow 122, tangential shearing is distinct and the fluid flow is less turbulent. In contrast, when the terminal lobe 108 is positioned upstream in relation to the direction of fluid flow 122, tangential shearing is more turbulent and less organized. Further, the plurality of projections 118 increase the surface area of the plurality of filter lobes 102, thereby decreasing the flow rate of the fluid. As discussed above, the lower flow rate may be advantageous in filtering larger particles to prevent or minimize damage to the filter lobes 102 and other components of the filtration device 100. In addition, the plurality of protrusions 120 may be advantageous for membranous filters by protecting the membranous filters from direct impacts from particles.

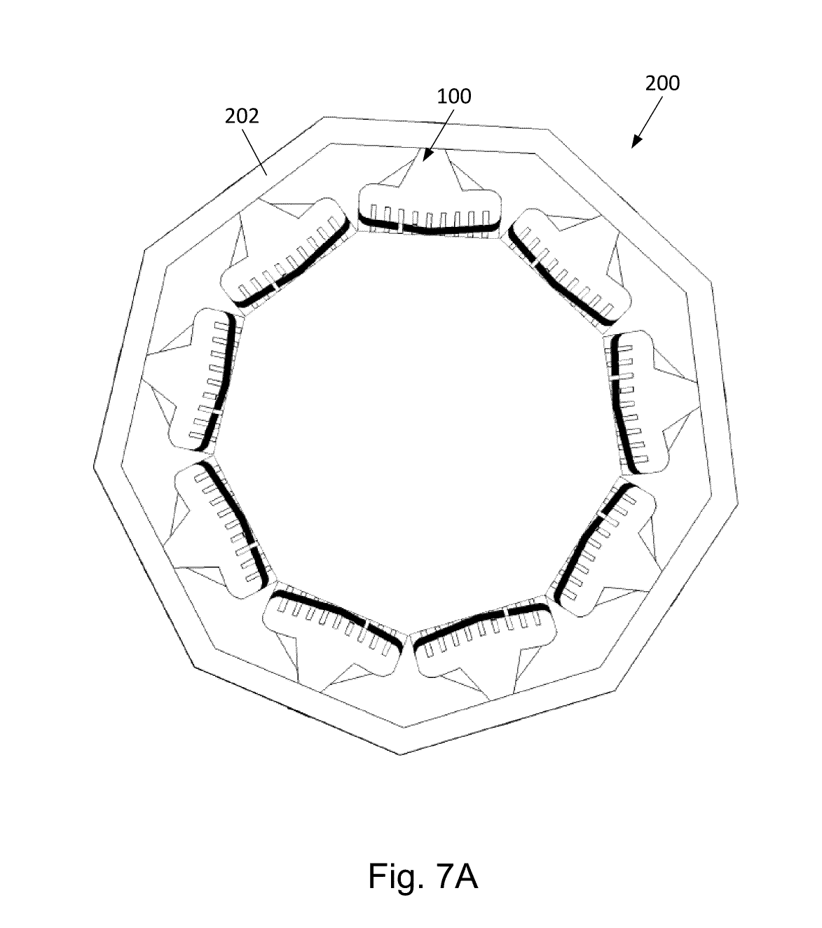

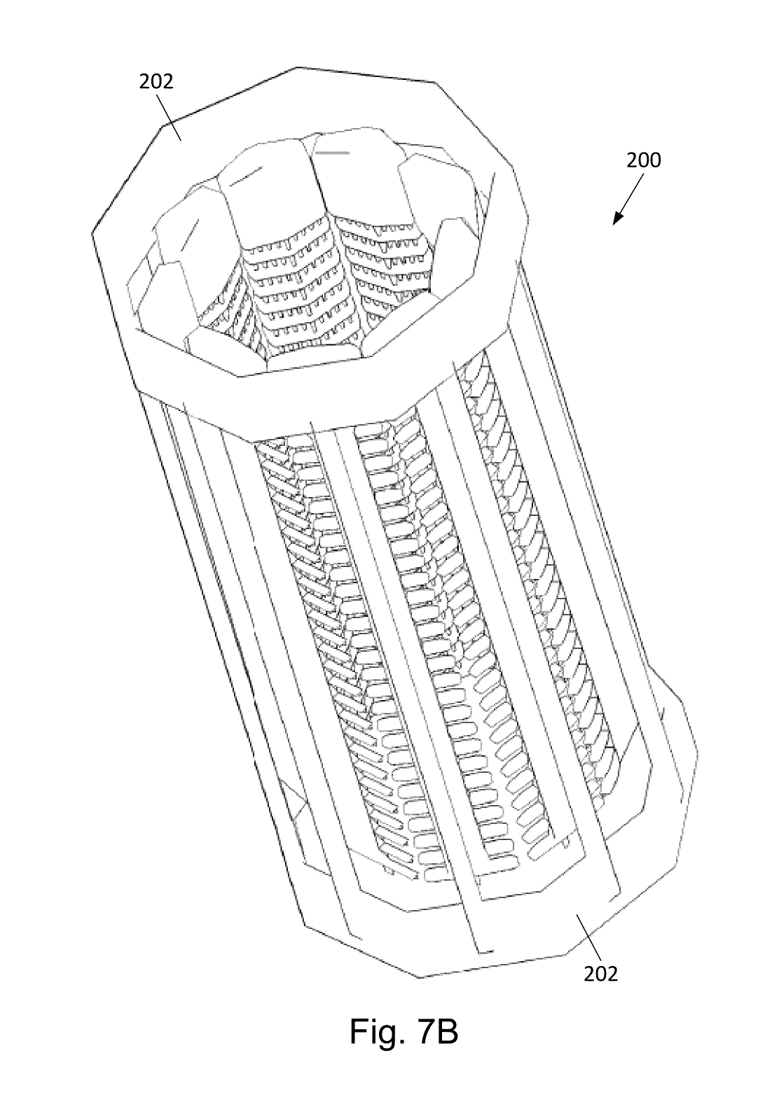

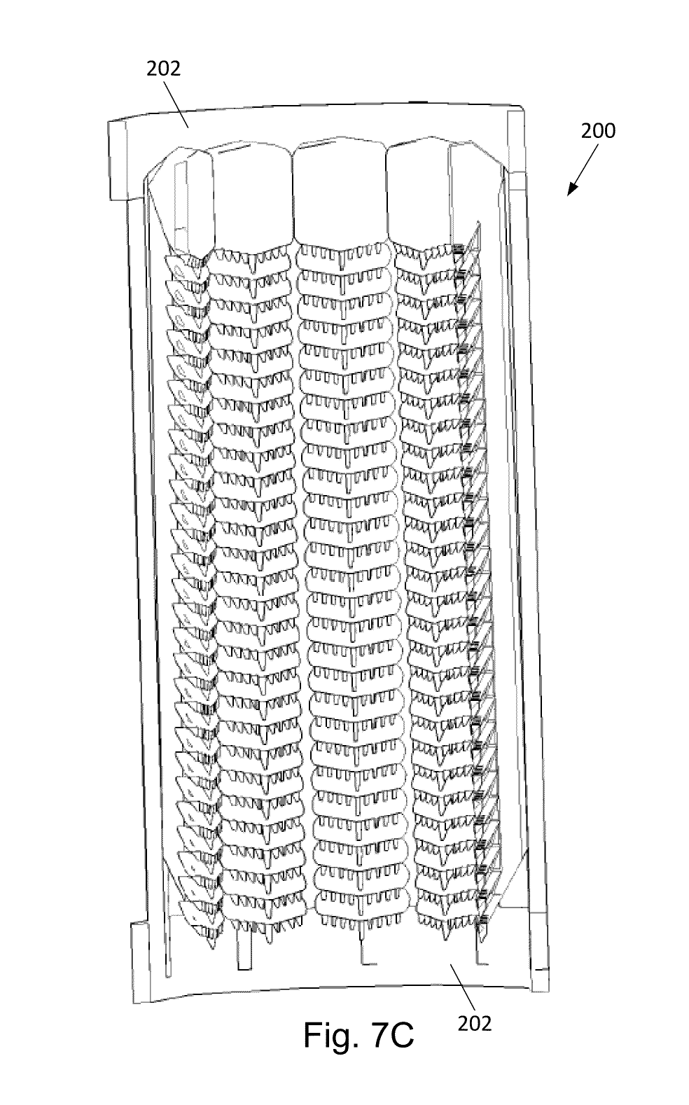

FIG. 7A illustrates a filtration system 200 according to an example embodiment. In particular, FIG. 7A illustrates a filtration system 200 comprising a plurality of the filtration devices 100. Each of the plurality of filtration devices 100 may have the features described above in relation to FIGS. 1A-6F. As shown in FIG. 7A, the spine of each of the plurality of filtration devices 100 are disposed on a common surface. In addition, a first end of the spine of each of the plurality of filtration devices 100 are coupled to a multi-sided support 202 such that the plurality of filter lobes face a center of the multi-sided support. As shown in FIGS. 7B-7C, a second end of the spine of each of the plurality of filtration devices 100 may be coupled to a second multi-sided support 204. In one particular example, as shown in FIGS. 7A-7C, the multi-sided supports comprise nine sides. Other embodiments are possible as well.

FIG. 7B illustrates perspective view of the filtration device 200. As shown in FIG. 7B, the plurality of filtration devices 100 disposed around the multi-sided supports 202, 204 collectively approximate a cylinder. FIG. 7C is a cross-sectional view of the filtration device 200.

In operation, the filtration system 200 may be positioned within a flow chamber, such as a pipe or other such configuration. In another example, the filtration system 200 may be self-contained such that the filtration system 200 acts as a flow chamber. In one example, the filtration device 200 may be positioned such that the longitudinal axis of the spine of each of the plurality of filtration devices 100 is positioned substantially parallel to a direction of fluid flow through the filtration system 200. In one embodiment, the filtration system 200 is positioned such that the terminal lobe of each of the plurality of filtration devices 100 is positioned upstream in relation to the direction of fluid flow. In such an embodiment, flow across each of the plurality of the filtration devices 100 is turbulent, which is more conducive to cyclonic filtration. In another embodiment, the filtration system 200 is positioned such that the terminal lobe of each of the plurality of filtration devices 100 is positioned downstream in relation to the direction of fluid flow. In such an embodiment, flow across each of the plurality of filtration devices 100 is laminar, which is more conducive to cross-flow filtration. Each of the plurality of filtration devices 100 may include a plurality of filter lobes. As discussed above, each of the plurality of filter lobes may include secondary surface structures, such as projections or protrusions, as discussed above.

In addition, the filtration system 200 may be adjustable such that the angle between a longitudinal axis of one or more spines of the plurality of filtration devices 100 and the direction of fluid flow can be changed during operation. In one example, the filtration system 200 may include one or more motors connected to the one or more spines, where the one or more motors are configured to adjust the angle between the longitudinal axis of the one or more spines and a direction of fluid flow through the filtration system 200. As discussed above, such a motor may be an electric motor powered by electrical power, or may be powered by a number of different energy sources, such as a gas-based fuel or solar power. In one example, the one or more motors may be configured to adjust the angle of the longitudinal axis of each of the spines of the plurality of filtration devices 100 with respect to the fluid flow are the same. In another example, the one or more motors may be configured such that the angle of the longitudinal axis of each of the spines of the plurality of filtration devices 100 with respect to the fluid flow are different.

In another example, the filtration device may include one or more actuators to the one or more spines, where the one or more actuators are configured to adjust the angle between the longitudinal axis of the one or more spines and a direction of fluid flow through the filtration system 200. Such an actuator may be an electro-mechanical actuator, including an electric motor configured to convert a rotary motion of the electric motor to a linear displacement. Other potential actuators are possible as well, such as hydraulic actuators, pneumatic actuators, piezoelectric actuators, linear motors, or telescoping linear actuators, as examples.

In addition, the filtration system 200 may include a controller (e.g., a microprocessor, FPGA, microcontroller, or the like) configured to adjust the angle between the longitudinal axis of the one or more spines and a direction of fluid flow through the filtration system 200. In one example, the filtration system 200 may further include a spectrometer configured to measure a size of particles present in the liquid, and transmit the determined particle size to the controller. The controller may then cause the one or more motors and/or one or more actuators to automatically adjust the angle between the longitudinal axis of the one or more spines and a direction of fluid flow through the filtration system 200 based on the determined particle size. In another example, the angle between the longitudinal axis of the one or more spines and a direction of fluid flow through the filtration system 200 may be adjusted manually via human input at a user interface. Other examples are possible as well.

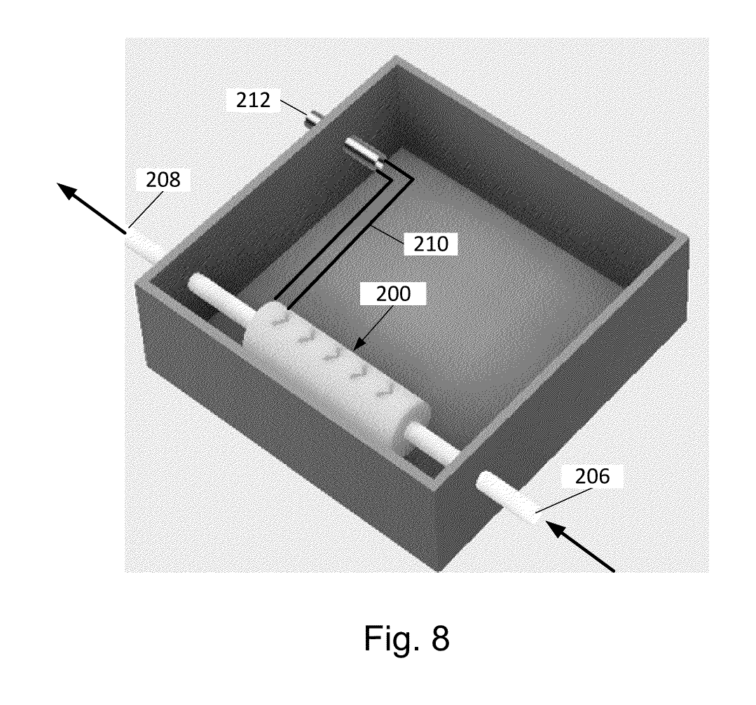

FIG. 8 illustrates an example filtration system, according to an example embodiment. In particular, FIG. 8 illustrates the filtration system 200. A first end of the filtration system 200 is coupled to a fluid inlet 206. A second end of the filtration system 200 is coupled to a fluid outlet 208. In operation, a liquid is received into the fluid inlet 206. At this stage, the liquid contains a plurality of waste particles. As the liquid passes through the filtration system 200, a plurality of waste particles are captured by the pores of each of the plurality of filter lobes of the filtration system 200. The waste particles are transferred from the plurality of pores into a waste channel 210, and removed from the system through a waste outlet 212.

In certain embodiments, such as shown in any one of FIGS. 1A-8, example filtration devices may be made using an additive-manufacturing process, such as stereolithography. As such, the example filtration devices described above may include a variety of materials, including calcium carbonate of poly(dimethylsiloxane) (PDMS), as examples. In one example, the additive-manufacturing process is a multi-material additive-manufacturing process such that various components of the filtration device may be formed using a material with a greater elasticity than the other components. For example, the plurality of filter lobes, as well as any projections or protrusions on the plurality of filter lobes, may be created with a material having greater elasticity than the spine and other components of the filtration device. Such a configuration may help minimize damage to the filtration device when the particles are large and hit the plurality of filter lobes at a high flow rate. Other examples are possible as well.

Each of the filtration devices described in FIGS. 1A-8 may represent a module, a segment, or a portion of program code, which includes one or more instructions executable by a processor or computing device for creating such devices using an additive-manufacturing system. The program code may be stored on any type of computer readable medium, for example, such as a storage device including a disk or hard drive. The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage device.

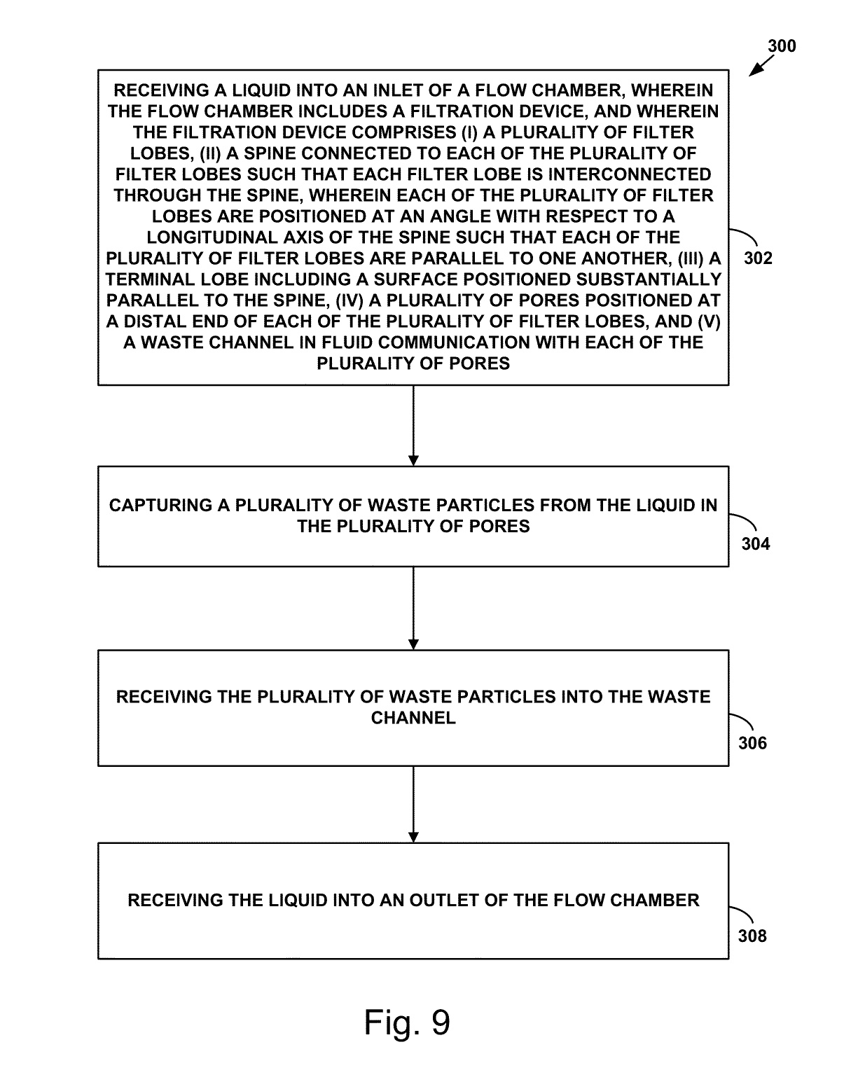

FIG. 9 is a block diagram of an example method for separating waste particles from a liquid. Method 300 shown in FIG. 9 presents an embodiment of a method that could be used by the filtration devices described in FIGS. 1A-8, as examples. Method 300 may include one or more operations, functions, or actions as illustrated by one or more of blocks 302-308. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

In addition, for the method 300 and other processes and methods disclosed herein, the block diagram shows functionality and operation of one possible implementation of present embodiments. In this regard, each block may represent a module, a segment, or a portion of program code, which includes one or more instructions executable by a processor or computing device for implementing specific logical functions or steps in the process. The program code may be stored on any type of computer readable medium, for example, such as a storage device including a disk or hard drive. The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage device.

In addition, for the method 300 and other processes and methods disclosed herein, each block in FIG. 3 may represent circuitry that is wired to perform the specific logical functions in the process.

Initially, at block 302, the method 300 includes receiving a liquid into an inlet of a flow chamber, wherein the flow chamber includes a filtration device. The filtration device may include (i) a plurality of filter lobes, (ii) a spine connected to each of the plurality of filter lobes such that each filter lobe is interconnected through the spine, wherein each of the plurality of filter lobes are positioned at an angle with respect to a longitudinal axis of the spine such that each of the plurality of filter lobes are parallel to one another, (iii) a terminal lobe including a surface positioned substantially parallel to the longitudinal axis of the spine, (iv) a plurality of pores positioned at a distal end of each of the plurality of filter lobes, and (v) a waste channel in fluid communication with each of the plurality of pores, (b) capturing a plurality of waste particles from the liquid in the plurality of pores, (c) receiving the plurality of waste particles into the waste channel, and (d) receiving the liquid into an outlet of the flow chamber.

At block 304, the method 300 includes capturing a plurality of waste particles from the liquid in the plurality of pores. Next, at block 306, the method 300 includes receiving the plurality of waste particles into the waste channel. Finally, at block 308, the method 300 includes receiving the liquid into an outlet of the flow chamber.

As discussed above in relation to FIGS. 2A-2B, the filtration device may be arranged in the flow chamber in a number of ways. In a first embodiment, the terminal lobe of the filtration device is positioned adjacent the outlet of the flow chamber. In a second embodiment, the terminal lobe of the filtration device is positioned adjacent the inlet of the flow chamber.

In one embodiment, the method may further include determining a size of one or more of the plurality of waste particles in the liquid, and based on the determined size, adjusting the angle between the longitudinal axis of the spine and the flow direction of the liquid through the flow chamber.

It should be understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location, or other structural elements described as independent structures may be combined.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only, and is not intended to be limiting.

Since many modifications, variations, and changes in detail can be made to the described example, it is intended that all matters in the preceding description and shown in the accompanying figures be interpreted as illustrative and not in a limiting sense. Further, it is intended to be understood that the following clauses (and any combination of the clauses) further describe aspects of the present description.

We claim:

1. A filtration device comprising:
a plurality of filter lobes;
a spine connected to each of the plurality of filter lobes such that each filter lobe is interconnected through the spine, wherein each of the plurality of filter lobes are positioned at an angle with respect to a longitudinal axis of the spine such that each of the plurality of filter lobes are parallel to one another;
a terminal lobe including a surface positioned substantially parallel to the longitudinal axis of the spine;
a plurality of pores positioned at a distal end of each of the plurality of filter lobes; and
a waste channel in fluid communication with each of the plurality of pores.

2. The filtration device of claim 1, further comprising a plurality of projections extending from a proximal end of each of the plurality of filter lobes.

3. The filtration device of claim 1, further comprising a plurality of protrusions positioned on a surface of each of the plurality of filter lobes.

4. The filtration device of claim 1, wherein each of the plurality of filter lobes are substantially planar.

5. The filtration device of claim 1, wherein the angle of each of the plurality of filter lobes with respect to the longitudinal axis of the spine is less than about 45 degrees.

6. The filtration device of claim 1, wherein the spine is connected to a center of each of the plurality of filter lobes.

7. The filtration device of claim 1, wherein the longitudinal axis of the spine is positioned substantially parallel to a direction of fluid flow through the filtration device.

8. The filtration device of claim 1, wherein an angle between the longitudinal axis of the spine and a direction of fluid flow through the filtration device is between 0 degrees and about 60 degrees.

9. The filtration device of claim 1, further comprising:
a motor connected to the spine, wherein the motor is configured to adjust an angle between the longitudinal axis of the spine and a direction of fluid flow through the filtration device.

10. The filtration device of claim 1, further comprising:
an actuator coupled to the spine, wherein the actuator is configured to adjust an angle between the longitudinal axis of the spine and a direction of fluid flow through the filtration device.

11. A filtration system, comprising a plurality of the filtration devices of claim 1, wherein the spine of each of the plurality of filtration devices are disposed on a common surface.

12. The filtration system of claim 11, wherein a first end of the spine of each of the plurality of filtration devices are coupled to a multi-sided support such that the plurality of filter lobes face a center of the multi-sided support.

13. The filtration system of claim 12, wherein the multi-sided support comprises as many as nine sides.

14. The filtration system of claim 12, further comprising:
one or more motors coupled to one or more of the spines of the plurality of filtration devices, wherein the one or more motors are configured to adjust an angle between a longitudinal axis of the one or more spines of the plurality of filtration devices and a direction of fluid flow through the filtration device.

15. The filtration system of claim 12, further comprising:
one or more actuators coupled to one or more of the spines of the plurality of filtration devices, wherein the one or more actuators are configured to adjust an angle between a longitudinal axis of the one or more spines of the plurality of filtration devices and a direction of fluid flow through the filtration device.

16. A non-transitory computer readable medium having stored thereon instructions, that when executed by one or more processors, cause an additive manufacturing machine to create the filtration device of claim 1.

17. A method for separating waste particles from a liquid, the method comprising:
receiving a liquid into an inlet of a flow chamber, wherein the flow chamber includes the filtration device of claim 1;
capturing a plurality of waste particles from the liquid in the plurality of pores;
receiving the plurality of waste particles into the waste channel; and
receiving the liquid into an outlet of the flow chamber.

18. The method of claim 17, further comprising:
determining a size of one or more of the plurality of waste particles in the liquid; and
based on the determined size, adjusting an angle between the longitudinal axis of the spine and a flow direction of the liquid through the flow chamber.

19. The method of claim 17, wherein the terminal lobe of the filtration device is positioned adjacent the outlet of the flow chamber.

20. The method of claim 17, wherein the terminal lobe of the filtration device is positioned adjacent the inlet of the flow chamber.
